(19) United States
(12) Patent Application Publication
(10) Pub. No.: US 2011/0259206 A1
(43) Pub. Date: Oct. 27, 2011

(54) Pot for Evenly Brewed Tea/Coffee

(76) Inventor: Martin Oliver Brennan, Galway (IE)

(21) Appl. No.: 12/764,386

(22) Filed: Apr. 21, 2010

(51) Int. Cl. A47J 31/44; A47G 19/14

(52) U.S. Cl. 99/304; 99/323

(57) ABSTRACT

A teapot/coffeepot with two chambers, a primary chamber 1 with tea only (e.g. teabags+hot water) and a secondary chamber 2 with hot water only divided by a sloped wall 3 between the chambers. For tea to be poured, the user must lift the teapot at an angle to cause the tea to flow out of the spout. Using this lifting or pouring action on the present invention, causes water to be simultaneously poured from the secondary water only chamber 2, into the primary tea chamber 1. This improves the consistency of the tea strength by diluting the tea remaining in the tea only chamber and thus preventing it becoming too strong for subsequent consumption.

### FIELD OF INVENTION

The present invention relates to a teapot design that improves the consistency of tea strength.

Equally, the invention relates to a pot for coffee or other beverage brewed in a similar way.

### BACKGROUND

When tea is left in a conventional one chamber teapot, the tea continues to brew. This results in the flavour of tea becoming stronger over time. Often water needs to be added to weaken the tea to satisfy the taste of the user.

### STATEMENT OF INVENTION

To overcome this, the present invention proposes the design of an additional chamber with ‘water only’ to maintain the tea strength. This means the pot is divided into two chambers. A primary chamber with tea only (e.g. teabags+hot water) and a secondary chamber with hot water only. For tea to be poured, the user must lift the teapot at an angle to cause the tea to flow out of the spout. Using this lifting or pouring action on the present invention, causes hot water to be simultaneously poured from the secondary water chamber, into the primary tea chamber. This improves the consistency of the tea strength by diluting the tea remaining in the tea only chamber and thus preventing it becoming too strong for subsequent consumption.

### ADVANTAGES

Tea poured from the teapot will be a more consistent strength for the period of time the teapot is used.

The level of caffeine intake can be more regulated.

The invention is inexpensive to manufacture.

A smaller volume ‘tea only’ section means less tea is needed per pot.

### BRIEF DESCRIPTION OF THE DRAWINGS

FIG. 1 shows a teapot with two chambers and a dividing wall.

FIG. 2 illustrates a two chambered pot by showing a teapot within a teapot

FIG. 3 shows a perspective drawing of a two chambered teapot.

FIG. 4a shows a teapot pouring a cup of tea.

FIG. 4b shows the same teapot as in FIG. 4a pouring a second cup of tea.

FIG. 5 shows a teapot with a chamber wall that is the same slope as the front face of the teapot.

FIG. 6a shows a tea pot with a varying wall slope, where the steepness of the slope decreases from top to bottom.

FIGS. 6b shows a top-view of FIG. 6a with the lid removed.

### DETAILED DESCRIPTION

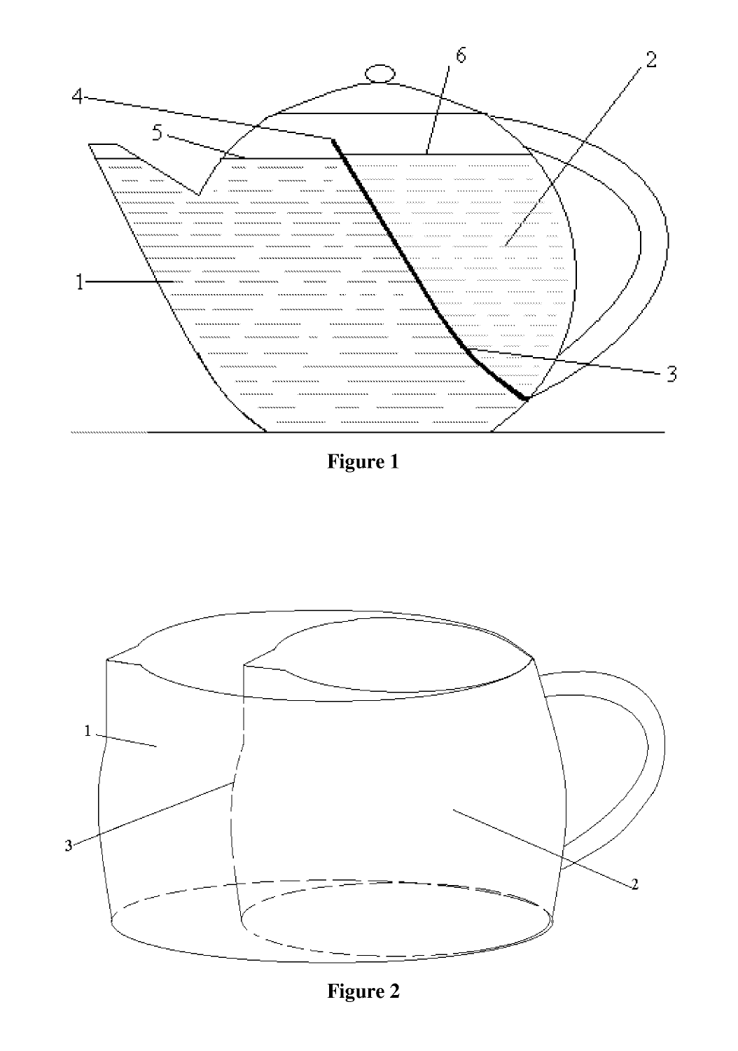

In FIG. 1, a conventional one chamber teapot is divided into two chambers, a primary tea chamber 1 (hot water+tea leaves) and a secondary hot water chamber 2. The wall 3 dividing the chambers extends from the bottom or handle side of the teapot to the top of the teapot. The height 4 of the chamber wall 3 is higher than the level of tea 5 in chamber 1 and higher than the level of water 6 in the water chamber 2.

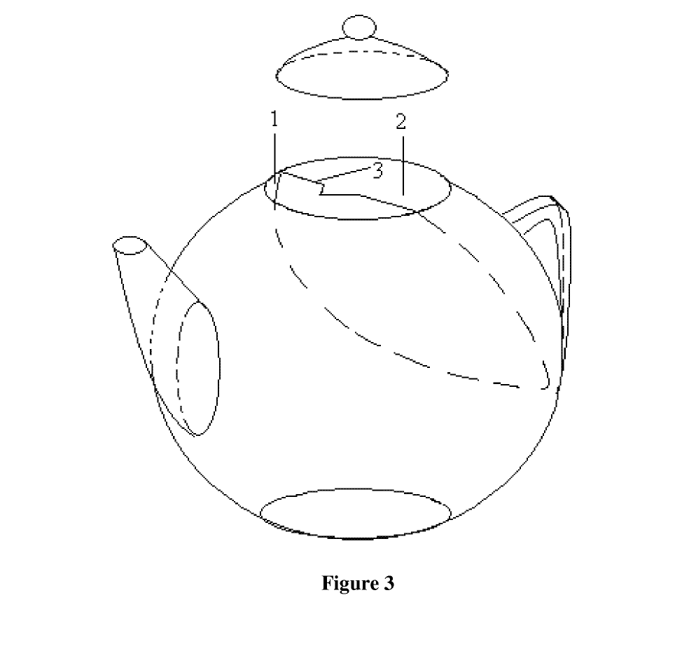

FIGS. 2 and 3 show further illustrations of a two chambered teapot. FIG. 2 shows a teapot within a teapot, this illustrates the basic premise of a two chamber teapot. FIG. 3 shows a perspective drawing of a two chamber teapot.

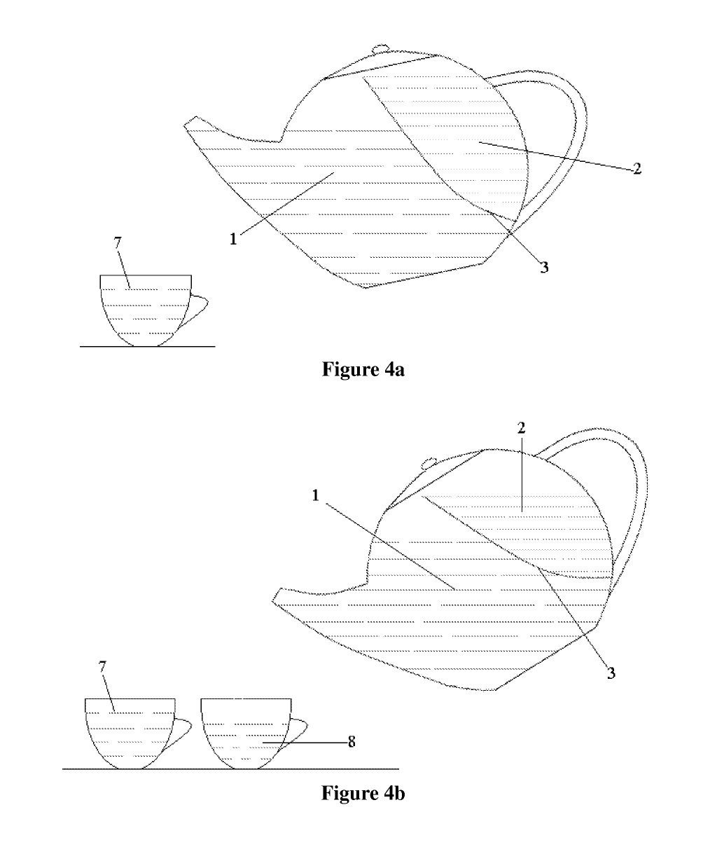

Referring to FIGS. 4a and 4b, FIG. 4a shows a cup of tea 7 being filled from a two chamber teapot. As the tea is poured from the tea chamber 1 into the cup 7, water is automatically pouring from the water chamber 2 into the tea chamber 1. FIG. 4b shows a second cup of tea 8 being filled. As the tea is poured from the tea chamber 1 into the cup 8, water is automatically pouring from the water chamber 2 into the tea chamber 1.

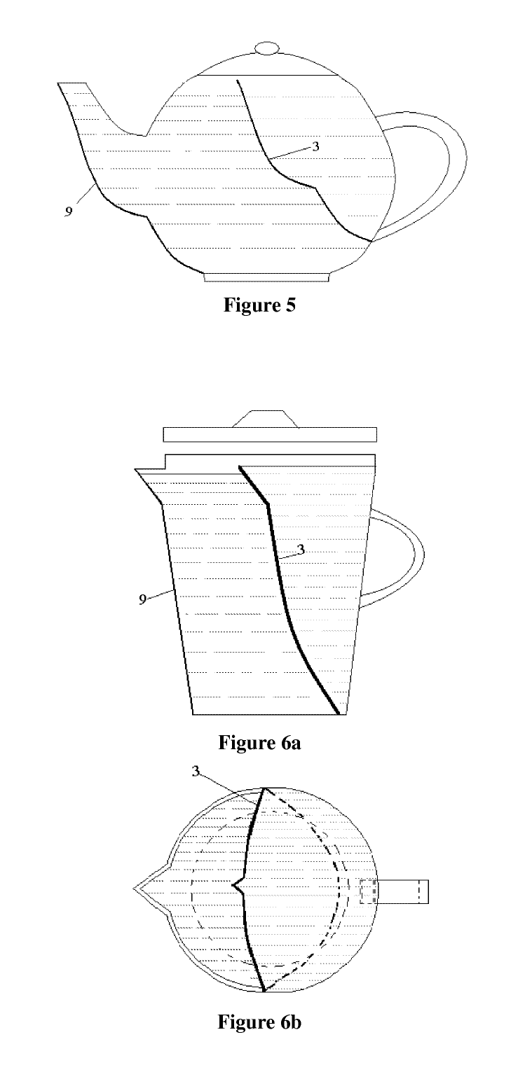

Referring to FIGS. 5 and 6a. The slope of the chamber wall 3 dictates the rate of flow of water from the hot water chamber 2 into the tea chamber 1. The slope of the chamber wall 3 can be the same as the slope of the front face 9 of the pot as per FIG. 5, or the slope of the chamber wall 3 can be different to the front face 9 as per FIG. 6a.

As the tea in the tea chamber 1 becomes stronger over time it may be more suitable to have an increased flow of water into the tea chamber 1 from the hot water chamber 2. This can be accomplished as per FIG. 6a by designed the slope of wall 3 such as to increase the flow rate from the water only chamber 2 into tea chamber 1 as the pot is emptied. FIG. 6b shows a top view of FIG. 6a without the lid in place.

As can be seen from the pots in FIGS. 1 to 6, the wall slope and size of the chambers can be varied in a number of ways. The slope of the wall 3 will control the rate of flow and hence the rate of dilution. The size of the water chamber 2 needs to be such that the amount of water containing within is sufficient to provide the amount of dilution required in chamber 1.

The chamber size and wall size/slope can be optimised by an individual/company experienced in the tea/beverage industry by identifying consumer drinking habits/preferences and thus calculating the required dilution.

1. A container such as a tea pot that is divided into two chambers, a primary chamber for tea (hot water+tea leaves/bags) and a secondary chamber for hot water with a common wall between them that allows, an amount of water to flow from the secondary water only chamber into the tea chamber, when the teapot is sloped at an angle i.e. during the time in which the tea is being poured from the pot.

2. A container according to claim 1 where the wall is sloped in such a way as to control the flow of water from water only chamber into the tea chamber.

3. A container according to claim 1 where said container could alternatively have more than one hot water chamber.

4. A container according to claim 1 where said container could be a container used to brew any beverage in a similar way to tea e.g. Coffee.

5. A container according to claim 2 where the wall can be sloped in such a way as to increase the flow of water from the water only chamber into the tea chamber as the tea chamber is emptied.
